(19) United States
(12) Patent Application Publication
(10) Pub. No.: US 2026/0264473 A1
(43) Pub. Date: Sep. 10, 2026

(54) THERMAL MANAGEMENT APPARATUS HAVING REDUCED COMPLEXITY FOR USE IN THERMAL MANAGEMENT SYSTEM

(71) Applicant: BorgWarner Inc., Auburn Hills, MI (US)

(72) Inventors: James Li, Ningbo (CN); Bryan Xu, Ningbo (CN); Ross J. Solanskey, Shelby Township, MI (US); Ketan Adhvaryu, Shelby Township, MI (US)

(21) Appl. No.: 19/549,136

(22) Filed: Feb. 25, 2026

Related U.S. Application Data
(60) Provisional application No. 63/767,096, filed on Mar. 5, 2025.

(51) Int. Cl. B60H 1/00; F28D 9/00; F28D 21/00; F28F 3/02

(52) U.S. Cl. CPC B60H 1/00885; B60H 1/00278; B60H 1/00342; F28D 9/0043; F28D 21/00; F28F 3/025; F28D 2021/0029

(57) ABSTRACT

A thermal management apparatus and associated thermal management system include a housing having an inlet and outlet port for a working fluid, the housing including an internal plate having a first and an opposing second surface, the second surface including one or more internal plate flow restrictor components. The apparatus and system also include a heating plate disposed within the housing adjacent to and spaced from the internal plate, the heating plate having a first and an opposing second surface, the first surface of the heating plate including one or more heating plate flow restrictor components and the second surface including one or more heating elements, wherein the heating plate flow restrictor components and the internal plate flow restrictor components each partially define a flow path for the working fluid therebetween with the heating elements heating the working fluid between the inlet and outlet port.

### CROSS REFERENCE TO RELATED APPLICATIONS

The present disclosure claims priority from U.S. Provisional App. Ser. No. 63/767,096, filed Mar. 5, 2025, the entirety of which is herein incorporated by reference.

### BACKGROUND

Hybrid and electric vehicles have distinct thermal management requirements compared to conventional internal combustion engine vehicles. Particularly, neither hybrid nor electric vehicles have an “always-on” internal combustion engine which constantly supplies heat energy for thermal management purposes. Furthermore, optimal performance, durability, and safety of key components of hybrid and electric vehicles, such as batteries and electric motors, are dependent on operating temperatures. Current thermal management systems for hybrids and electric vehicles typically utilize electric heaters including, for example, high voltage coolant heaters (HVCH), to heat working fluids such as coolant, to assist with thermal management operations such as heating the passenger cabin, to regulate battery temperature, etc. However, these HVCH heaters are typically overly complex and costly to design.

### SUMMARY OF THE PRESENT DISCLOSURE

The subject disclosure is directed to thermal management apparatuses for use in thermal management systems having reduced cost and complexity while still providing the desired heating performance for use in hybrids and electric vehicles.

In certain embodiments, the thermal management apparatus includes a housing having an inlet port and an outlet port for the working fluid. The housing also includes an internal plate having a first surface and an opposing second surface, with the second surface including one or more internal plate flow restrictor components. The thermal management apparatus also includes a heating plate disposed within the housing adjacent to and spaced from the internal plate, the heating plate having a first surface and an opposing second surface, the first surface of the heating plate including one or more heating plate flow restrictor components and the second surface of the heating plate including one or more heating elements. The one or more heating plate flow restrictor components on the first surface of the heating plate and the one or more internal plate flow restrictor components on the second surface of the internal plate each partially define a flow path for the working fluid therebetween with the one or more heating elements in thermal communication with the flow path for heating the working fluid as the working fluid flows through the flow path between the inlet port and the outlet port.

The arrangement of the internal plate flow restrictor components relative to the arrangement of the heating elements and heating plate flow restrictor components, with the associated reduction in the amount of heating elements and heating plate flow restrictor components, reduces complexity and cost of the heating plate assembly in combination with internal plate, and a corresponding reduction in the complexity and cost of the thermal management apparatus and system, while maintaining the desired level of heating performance in the thermal management apparatus and system for heating or cooling the various components of the thermal management system.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a schematic representation of one implementation of the thermal management system according to the present disclosure operating in the first operational mode.

FIG. 2 is a schematic representation of the thermal management system of FIG. 1 operating in the second operational mode.

FIG. 3 is a partially schematic exploded view of the thermal management apparatus in accordance with the prior art.

FIG. 4 is a partially schematic exploded perspective view of the thermal management apparatus of FIG. 1 in accordance with one exemplary embodiment of the subject disclosure.

FIG. 5 is another partially schematic exploded perspective view of FIG. 4.

FIG. 6 is a section view of the housing of FIG. 4.

FIG. 7 is a perspective view of the housing of FIGS. 3 and 4.

FIG. 8 is a perspective view of the housing and heating plate of FIG. 4.

FIG. 9A is a bottom view of the housing and internal plate of FIG. 4 in accordance with one exemplary embodiment of the present disclosure.

FIG. 9B is a bottom view of the housing of FIG. 9A with the coupled to or brazed fins of the heating plate of FIGS. 4 and 5 included and disposed adjacent to the internal plate.

FIG. 10A is a bottom view of the housing and internal plate of FIG. 4 in accordance with another exemplary embodiment of the present disclosure.

FIG. 10B is a bottom view of the housing of FIG. 10A with the fins of the heating plate of FIGS. 4 and 5 included and disposed adjacent to the internal plate.

FIG. 11A is a bottom view of the housing and internal plate of FIG. 4 in accordance with yet another exemplary embodiment of the present disclosure.

FIG. 11B is a bottom view of the housing of FIG. 11A with the fins of the heating plate of FIGS. 4 and 5 included and disposed adjacent to the internal plate.

FIGS. 12-19 are perspective views of the housing in accordance with additional exemplary embodiments of the present disclosure having slightly varying designs of the fin diverters disposed on a portion of the lower surface of the housing.

FIG. 20 is a perspective view of a heating plate assembly of FIGS. 4 and 5 in accordance with still another exemplary embodiment of the present disclosure.

FIG. 21 is another perspective view illustrating the opposite side of the heating plate assembly of FIG. 20.

### DETAILED DESCRIPTION

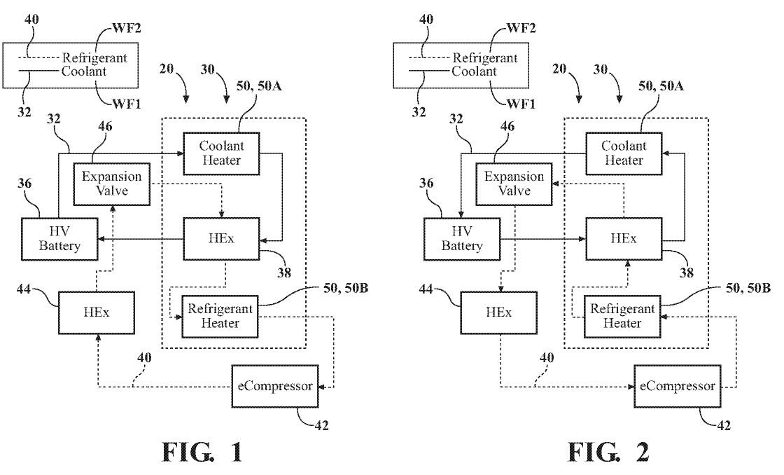

FIGS. 1 and 2 illustrate a portion of a vehicle 20 including at least one thermal management apparatus 50. The vehicle 20 may be a hybrid electric vehicle (“hybrid”) or an electric vehicle (“EV”). In particular, the subject disclosure is directed to various alternative configurations of a heating plate assembly 60 used in the thermal management apparatus 50.

As best shown in FIGS. 1 and 2, a first thermal management apparatus 50, 50A is included as one component of a thermal management system 30 for these vehicles 20 that allows a first working fluid WF1 (such as a coolant 32) to flow through a first fluid loop 32 that includes a vehicle battery 36 and a heat exchanger 38 that are arranged in sets relative to each other. The thermal management apparatus 50, 50A, in certain embodiments and as illustrated below, is a high voltage coolant heater (HVCH).

The thermal management system 30 also typically includes a second fluid loop 40 that allows a second working fluid WF2 (such as a refrigerant 40) to flow between the heat exchanger 38, a second thermal management apparatus 50, 50B, a compressor 42, a vehicle cabin heat exchanger 44, and an expansion valve 46 arranged in sets relative to each other. In certain embodiments, it is recognized that the second thermal management apparatus 50, 50B (which may also be a high voltage coolant heater (HVCH)), a compressor 42, a vehicle cabin heat exchanger 44, and an expansion valve 46 of the second fluid loop 40 may be in communication with the first fluid loop 32 (and hence the first working fluid WF1 and the second working fluid WF2 are the same working fluid WF).

FIGS. 1 and 2 provide a schematic example of one implementation of the thermal management system 30 operating in the first operational mode (shown in FIG. 1) and the second operational mode (shown in FIG. 2).

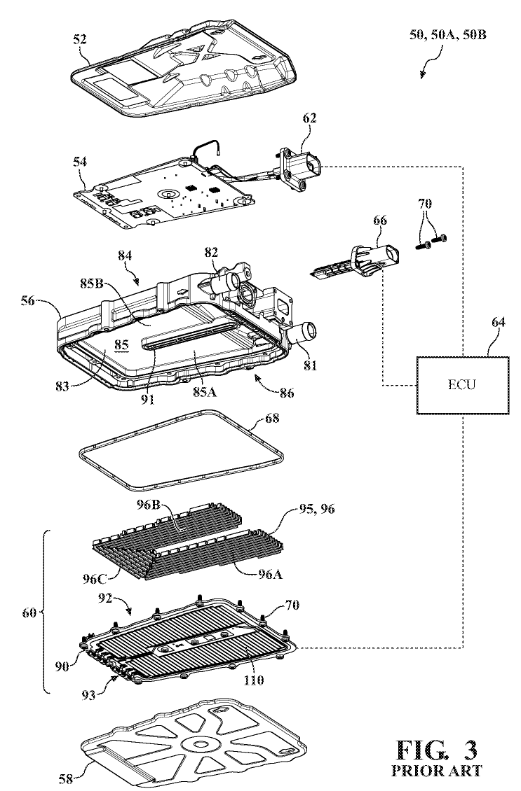

Referring to FIG. 1, a controller (not shown in FIG. 1, but described below and added schematically to FIGS. 3-5 as electronic control unit (“ECU”) 64) may be configured to operate the thermal management system 30 in the first operational mode in response to a scenario where the vehicle cabin heat exchanger 44 has a high heat demand. Here, there are at least three potential sources of heat for the vehicle cabin heat exchanger 44 – namely, the first thermal management apparatus 50, 50A, the second thermal management apparatus 50, 50B, and the compressor 42. Accordingly, the controller 64 may be configured to operate the thermal management system 30 in the first operational mode such that the first thermal management apparatus 50, 50A heats the first working fluid WF1, which then flows through the heat exchanger 38 to heat the second working fluid WF2, which is then subsequently further heated by the second thermal management apparatus 50, 50B, and finally provided to the cabin heat exchanger 44. In effect, the second working fluid WF2 receives the benefit of being heated (directly or indirectly) by both the first thermal management apparatus 50, 50A and the second thermal management apparatus 50, 50B, thereby allowing more heat to be provided to the cabin heat exchanger 44 than otherwise possible without utilizing higher capacity heating elements for the first and second fluid loops 32, 40. In other words, the thermal management system 30 in accordance with the present disclosure includes the controller 64 and the thermal management apparatus 50, 50A, 50B.

Referring to FIG. 2, the controller may be configured to operate the thermal management system 30 in the second operational mode in response to a scenario where the vehicle battery 36 has a high heat demand (e.g. where the vehicle battery 36 is being pre-conditioned to receive a fast charge). Here, there are at least three potential sources of heat for the vehicle battery 36 – namely, the first thermal management apparatus 50, 50A, the second thermal management apparatus 50, 50B, and the compressor 42. Accordingly, the controller may be configured to operate the thermal management system 30 in the second operational mode such that the second thermal management apparatus 50, 50B heats the second working fluid WF2, which then flows through the heat exchanger 38 to heat the first working fluid WF1, which is then subsequently further heated by the first thermal management apparatus 50, 50A and finally provided to the vehicle battery 36. Again, in effect, the first working fluid WF1 receives the benefit of being heated (directly or indirectly) by both first thermal management apparatus 50, 50A and the second thermal management apparatus 50, 50B, thereby allowing more heat to be provided to the vehicle battery 36 than otherwise possible without utilizing higher capacity heating elements for the first and second fluid loops 32, 40.

As noted above, the subject disclosure is directed to modifications to one or both of the thermal management apparatus 50, 50A, 50B that reduce complexity and cost while having minimal or no impact on the ability of the apparatus 50, 50A, 50B to operate in the first or second operational mode. It is appreciated that the thermal management apparatus 50, 50A, 50B could be the HVCH, but is not necessarily the HVCH in all instances.

While the description and Figures are directed to thermal management systems 30 including a pair of thermal management apparatus 50A and 50B, the present disclosure is also equally applicable to thermal management systems 30 having a single thermal management apparatus 50 and a single flow of working fluid WF in a single loop coupled to the vehicle battery 36, and to thermal management systems 30 having more than a pair of thermal management apparatus 50.

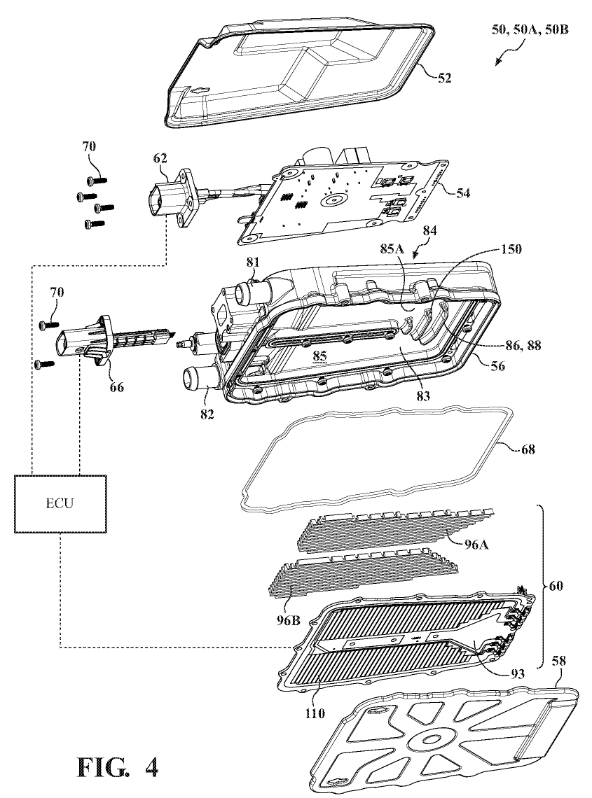

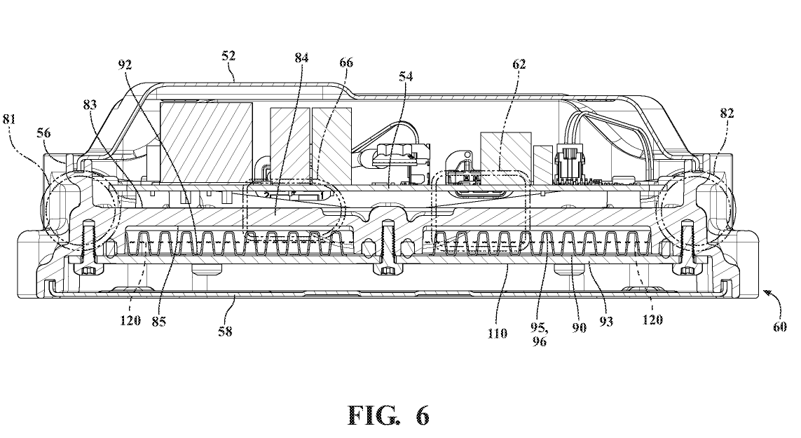

In each of the examples, and in accordance with an exemplary embodiment of the present disclosure as best illustrated in FIGS. 4-6, the thermal management apparatus 50, 50A, 50B (collectively referred to hereinafter as thermal management apparatus 50) includes, as its general major components, a printed circuit board cover 52, a printed circuit board 54, a housing 56, and a coolant cover 58 in addition to the heating plate assembly 60.

Additional components on the thermal management apparatus 50 also shown in FIGS. 4-6 include a low voltage connector 62, which mates with the printed circuit board 54 and allows communication with electronic control unit 64 (“ECU 64”), and a high voltage connector 66, which mates with a high voltage power source located on the vehicle 20. The ECU 64 may be incorporated into a portion of the housing 56, or may be located remotely from the housing 56 and other components of the thermal management apparatus 50. A coolant seal 68 seals the heating plate assembly 60 to the housing 56, with fastening devices 70 (shown here as screws) used to fasten the various components to the housing 56 and to compress the seals such as the coolant seal 68.

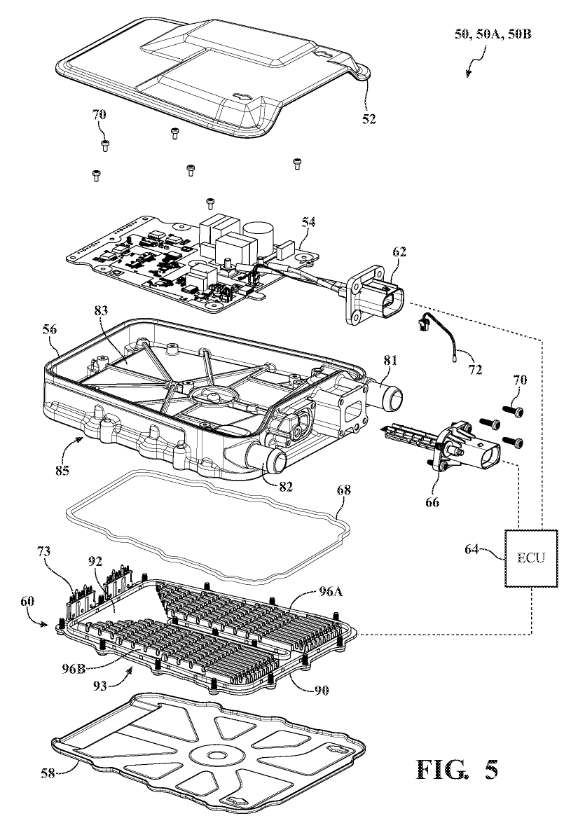

The thermal management apparatus 50 also includes terminals 73 (see FIG. 5) which transport electrical current and voltage between electrical components, a temperature sensor 72 for measuring the inlet temperature and outlet temperature of coolant. The thermal management apparatus 50 also typically includes an insulation layer that functions to insulate the printed circuit board 54.

The housing 56 defines or otherwise includes one or more inlet ports 81 (a single inlet port 81 is shown in FIGS. 4-6) through which the coolant or refrigerant (from the first fluid loop 32 or the second fluid loop 40) is received within the housing 56, and one or more outlet ports 82 (a single outlet port 82 is shown in FIGS. 4-6) through which coolant or refrigerant leaves the housing 56 and returns to the respective first fluid loop 32 or the second fluid loop 40.

The housing 56 also includes an internal plate 83 that that has an first surface 84 (i.e., an upper surface 84) upon which the printed circuit board 54 is seated and an opposing second surface 85 (i.e., a lower surface 85) positioned adjacent to but spaced from the heating plate assembly 60, with the lower surface 85 and the heating plate assembly 60 defining a fluid cavity 86 therebetween that is fluidically coupled to both the inlet port 81 and outlet port 82. In the illustrated embodiments, the internal plate 83 is integrally formed with the housing 56 (such as being cast with the housing 56), but in alternative embodiments the internal plate 83 may be a separate component that is coupled to, or sealingly attached to or otherwise affixed to the housing 56.

The construction of the internal plate 83, from a material perspective, may be comprised of any suitable material that is compatible with the working fluid WF and the operating temperature thereof. For example, the internal plate 83 may be comprised of a metal/metal alloy (such as steel, aluminum, etc.) or a plastic/composite. The outer shape of the internal plate 83 is likewise not particularly limited for the purposes of this disclosure other than it is sized to fit within the housing 56 and as otherwise described below.

Typically, and as illustrated for example in FIG. 3 in conventional prior art designs, the lower surface 85 of the internal plate 83 is a generally flat surface along its length between the inlet port 81 and outlet port 82 that cooperates with the heating plate assembly 60, as described further below, to define the heating plate assembly flow path 120 for the working fluid WF (i.e., WF1 or WF2, as shown in FIGS. 1 and 2) between the inlet port 81 and outlet port 82. A central wall 91 extending transverse from the lower surface 85 separates the inlet side, corresponding to the inlet port 81, and outlet side, corresponding to the outlet port 82 to allow the working fluid WF to flow along a c-shaped flow path over the substantial majority of lower surface 85 between the inlet port 81 and outlet port 82.

In accordance with the present disclosure, however, as illustrated in FIGS. 4-19, a portion of the lower surface 85, includes fin diverters 86 coupled to or brazed onto the lower surface 85 and/or includes flow altering components 87 disposed on, or otherwise operatively attached or coupled to, the lower surface 85 (or second surface 85), with the fin diverters 86 and flow altering components 87 collectively referred to as flow restrictor components 88, or more specifically internal plate flow restrictor components 88 (i.e., the second surface 85 of the internal plate 83 including one or more internal plate flow restrictor components 88), which cooperate with a modified heating plate assembly 60 to redefine the flow path 120 for the working fluid WF between the inlet port 81 and the outlet port 82, as will be explained further below.

Referring back to FIGS. 4-5, the heating plate assembly 60 is defined by one or more heating plates 90, such as one or more stamped metallic heating plates 90, and may be referred to simply as a heating plate 90, which are coupled to each other to further define the heating plate assembly flow path 120 for the working fluid WF (i.e., WF1 or WF2, as shown in FIGS. 1-2). In the examples in accordance with exemplary embodiments of FIGS. 4-5 and 20-21 described further below, the heating plate assembly 60 is comprised of one or more aluminum heating plates 90 (a single aluminum heating plate 90 representative of one or more heating plates 90 is shown in the Figures for simplicity) which are brazed together.

Each individual heating plate 90, and the collection of heating plates 90, defines a first surface 92 and an opposing second surface 93. The first surface 92 of the outermost one of the heating plates 90 includes a set of stamped or cast components 94 (see FIG. 21) and/or includes a sets of components 95 (see FIGS. 4-5, 9B, 10B, 11B) disposed on, or otherwise operatively attached or coupled to, the first surface 92, which collectively may be referred to as flow restrictor components 96 or heating plate flow restrictor components 96 (i.e., the first surface 92 includes one or more heating plate flow restrictor components 96 so as to distinguish from the internal plate flow restrictor components 88 above), with the heating plate flow restrictor components 96 cooperating to further define the flow path 120 in cooperation with the lower surface 85 of the internal plate 83 between the inlet port 81 and the outlet port 82.

In addition, the heating plate assembly 60 includes one or more heating elements 110 operatively attached to the second surface 93 of an outermost one of the plates 90 (i.e., the second surface 93 includes one or more heating elements 110), with the heating elements 110 in thermal communication with the flow path 120 through the plates 90. In particular, the heating elements 110 are configured to generate heat in response to being energized to heat the working fluid WF as the working fluid WF flows through the flow path 120 within the fluid cavity 86 between the inlet port 81 and outlet port 82.

In this configuration, the one or more heating plate flow restrictor components 96 on the first surface 92 of the heating plate 90 and the one or more internal plate flow restrictor components 88 on the second surface 85 of the internal plate 83 each partially define the flow path for the working fluid WF therebetween with the one or more heating elements 110 in thermal communication with the flow path 120 for heating the working fluid WF as the working fluid WF flows through the flow path 120 between the inlet port 81 and the outlet port 82.

The heating elements 110 are typically electrical heating elements such as resistive heaters. The heating element 110 may be tubular/sheathed resistive heating elements, coiled resistive heating elements, screen-printed resistive heating elements, thermal spray resistive heating elements, positive-temperature-coefficient (PTC) heating elements, the like, and combinations thereof. The heating elements 110 are electrically coupled to the low voltage connector 62 and high voltage connector 66. In this arrangement, the ECU 64 is in communication with the heating assembly 60 through the low voltage connector 62 to energize the heating element 110 to heat the working fluid WF.

The construction of the heating plate assembly 60, from a material perspective, may be comprised of any suitable material that is compatible with the working fluid WF and the operating temperature thereof. For example, the heating plate assembly 60, or the plates 90 of the heating plate assembly 60, may be comprised of a metal/metal alloy (such as steel, aluminum, etc.) or a plastic/composite. The shape of the heating plate assembly 60 is likewise not particularly limited for the purposes of this disclosure. Any shape suitable for defining the heating plate assembly flow path 120 are contemplated.

As noted above, the heating plate assembly 60 further partially defines the flow path 120, with each flow path 120 extending between one of the inlet ports 81 and a corresponding one of the outlet ports 82. Each flow path 120 is configured to direct the working fluid WF (such as the first working fluid WF1 or the second working fluid WF2) between the inlet port 81 and the outlet port 82. It should be appreciated that in this context the phrase “between the inlet port 81 and the outlet port 82” is not limited in direction. For example, the working fluid WF may flow from the inlet port 81 to the outlet port 82 (such as when the thermal management system 30 is operating in the first operational mode (FIG. 1)), or from the outlet port 82 to the inlet port 81 (such as when the thermal management system 30 is operating in the second operational mode (FIG. 2)).

The composition of the working fluid WF is not particularly limited for the purposes of this disclosure. The working fluid WF may be a cooling fluid (i.e., a coolant) suitable for a vehicular application such as water, ethylene glycol, propylene glycol, and the like, particularly if used in the first fluid loop 32. The working fluid WF may also be a refrigerant suitable for a vehicular application such as 1,1,1,2-tetrafluoroethane (also known as R-134a), 2,3,3,3-tetrafluoropropene (also known as R1234yf), and the like, particularly if used in the second fluid loop 40.

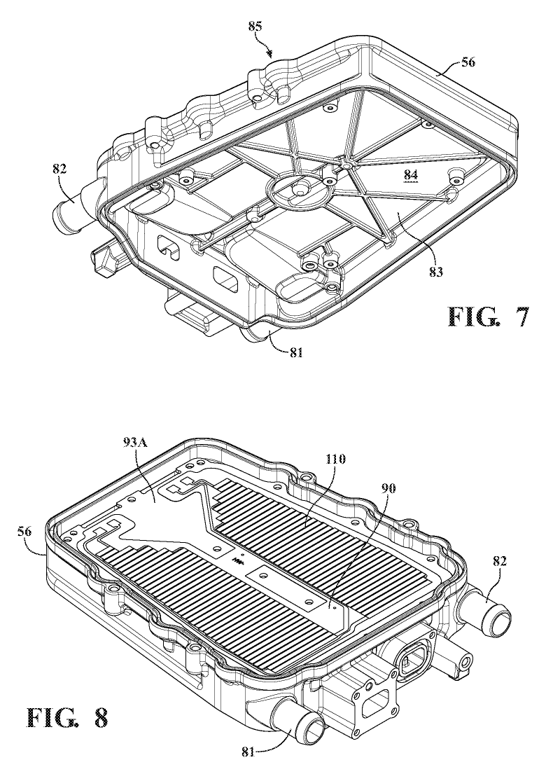

In certain embodiments, such as shown in FIGS. 7-19, the present disclosure relates specifically to the various configurations of the internal plate flow restrictor component 88, including more specifically the configuration of the fin diverters 86 coupled to or brazed onto the lower surface 85 86 and/or flow altering components 87 disposed or otherwise coupled or affixed on the second surface 85 of the internal plate 83 of the housing 56, as will be described in various embodiments below.

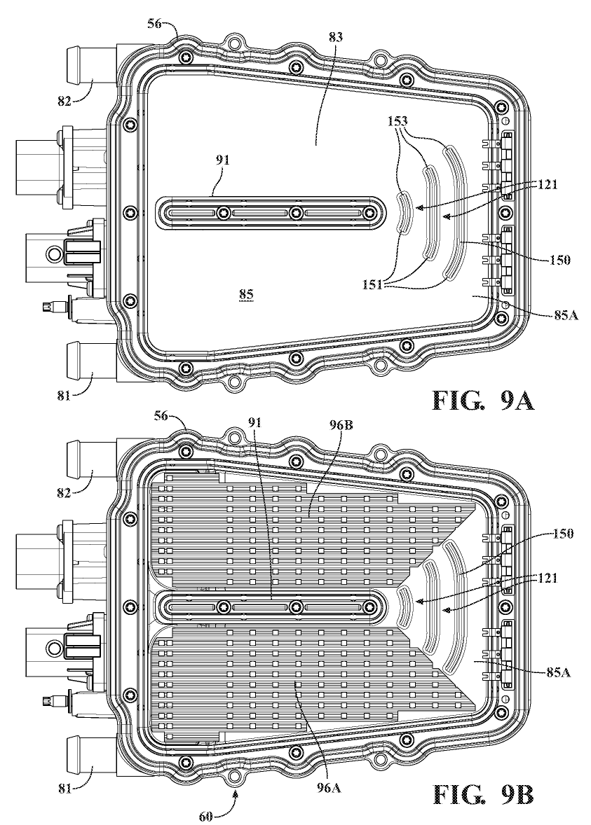

In certain related embodiments (as shown FIGS. 9B, 10B, 11B, and 20), the subject application also relates to the various configuration of the heating plate flow restrictor components 96, including more specifically the configuration of the stamped channels 94 and/or the components 95, on the one or more plates 90.

In each of these embodiments, the configuration of the heating plate flow restrictor components 96 on the heating plate 90 is coordinated with the configuration of the flow restrictor components 88 on the internal plate 83, to provide and partially define a flow path 120 for the working fluid WF between the inlet port 81 and outlet port 82 as will be described further below.

In still further related embodiments, the configuration of the one or more heating elements 110 on the outermost one of the plates 90 may be coordinated to the configuration of the heating plate flow restrictor components 96. In particular, the one or more heating elements 110 operatively attached to the second surface 93 of an outermost one of the plates 90 are aligned in size and shape with the heating elements 110 in thermal communication with the flow path 120 through the plates 90.

Referring to the prior art of FIG. 3, in conventional applications of the thermal management apparatus, the lower surface 85 of the internal plate 83 is generally flat, and includes a first flat portion 85A adjacent to the inlet port 81 and a second flat portion 85B adjacent to the outlet port 82 which are separated by a central wall 91. In addition, the internal plate 83 is paired with a heating plate assembly 60 with the vast majority of the surface area of the first surface 92 of the heating plate 90 between the inlet port 81 and outlet port 82 including sets of heating plate flow restrictor components 96 disposed thereon. In particular, the heating plate flow restrictor components 96 preferably include a first set 96A of fins coupled to, or brazed onto, the first surface 92 adjacent to the inlet port 81, and second set 96B of fins coupled to or brazed onto the first surface 92 adjacent to the outlet port 82, and a third set 96C of fins coupled to or brazed onto the first surface 92 opposite the inlet port 81 and outlet port 82 connecting the first set 96A to the second set 96B spaced from the central wall 91. The three sets 96A, 96B, 96C of fins 96 are shown in an exploded view in FIG. 3 without being coupled to or brazed onto the first surface 92 for ease of illustration.

In FIG. 3, the thickness of the three sets 96A, 96B, 96C of fins 96, in the assembled state, is such that there is a small gap to the corresponding first and second flat portion 85A, 85B of the internal plate 83 to define the fluid cavity 86 therebetween. Also the three sets 96A, 96B, 96C of fins 96 coupled to or brazed onto the first surface 92, collectively define the heating plate flow restrictor components 96 that cover a substantial majority, such as greater than ninety percent (90%), of the available surface area of the first surface 92 of the heating plate 90, corresponding to the portion of flow path 120. Also, each of the three sets 96A, 96B, 96C of fins 96 are coordinated in shape, with the first set 96A and second set 96B each separately aligned along an edge of the third set 96C of fins at a location opposite the inlet port 81 and outlet port 82. In this configuration, the three sets 96A, 96B, 96C of fins 96 coupled to or brazed onto the first surface 92, and the corresponding first and second flat portions 85A and 85B of the lower surface 85 of the internal plate 83, collectively define the flow path 120 of the working fluid WF within the fluid cavity 86 between the inlet port 81 and outlet port 82.

Accordingly, the working fluid WF that enters through the inlet port 81 and flows along a first portion of the flow path 120 adjacent to the first set 96A of fins and first flat portion 85A in a direction away from the inlet port 81. The first portion of the flow path 120 is restricted in direction internally by the central wall 91 as it moves away from the inlet port 81 such that it does not flow in a transverse direction towards the second set 96B of fins in areas adjacent to the central wall 91. Once reaching the opposite side of the housing 56, the flow path 120 diverts around the central wall 91 and onto a second portion of the flow path 120 adjacent to the second set 96B of fins and second flat portion 85B of the internal plate 83 after moving across the third set 96C of fins adjacent to the flat surface of the internal plate 83 between the first and second flat portion 85A, 85B and moves in a direction towards the outlet port 82. The second portion of the flow path 120 of the working fluid WF is restricted in direction internally by the central wall 91 as it moves towards the outlet port 82 such that it does not flow in a transverse direction towards a first set 86A of fin diverters 86 in areas adjacent to the central wall 91.

As also illustrated in FIG. 3, the corresponding configuration of heating elements 110 in conventional designs is assembled on the second surface 93 of the heating plate 90 to correspond to the first, second and third sets of fins 96A, 96B, 96C and covers the corresponding vast majority of the surface area of the second surface 93 of the heating plate 90.

By contrast, in alternative versions of the thermal management apparatus 50, 50A, 50B in accordance with the present disclosure and as illustrated in FIGS. 4-21, the configuration of the lower surface 85 of the internal plate 83, in combination with the configuration of flow restrictor components 96 coupled to or brazed onto the first surface 92 of the heating plate 90 of the heating plate assembly 60, are modified so as to reduce the complexity of the design and to reduce the surface area on the first and second surface 92, 93 of the heating plate 90 of the heating plate assembly 60 covered by the sets 96A, 96B, 96C of fins 96 alone or in combination with corresponding modifications to the design of the heating elements 110.

In certain exemplary embodiments described below, a portion of the first surface 92 of the heating plate 90 does not include the one or more heating plate flow restrictor components 96, and the one or more internal plate flow restrictor components 88 are positioned adjacent the portion of the first surface 92 of the heating plate 90 that does not include the one or more heating plate flow restrictor components 96.

In certain exemplary embodiments, such as shown in a representative manner in FIGS. 4 and 5, all or a portion of the third set 96C of fins 96 are removed from the first surface 92 of the heating plate 90 of the heated plate assembly 60. In combination therewith, internal plate flow restrictor components 88 in the form of one or more fin diverters 150, such as a plurality of spaced apart fin diverters 150, are coupled onto, and in certain embodiments, cast onto the lower surface 85 of the internal plate 83 corresponding to a first portion 85A of the lower surface 85 opposite the inlet port 81 and outlet port 82. Stated differently, the one or more internal plate flow restrictor components 88 comprise one or more fin diverters 150 coupled onto, or cast onto, the second surface 85 of the internal plate 83. The fin diverters 150 assist in directing the flow path 120 along various subchannels 121 to return the working fluid WF in a direction towards the outlet port 82 from the inlet port 81, or vice versa.

The fin diverters 150 are formed with more surface area than the first portion 85A of the lower surface 85, but occupy less surface area than the corresponding surface area removed by the third set 96C of fins removed from the heating plate 90 in combination with the removal of a corresponding portion of the heating elements 110 to leave an uncovered surface portion 93A, and are less complex to manufacture with less raw material usage. Notably, the reduction in the surface area of heating elements 110 and the third set 96C of fins (in combination with the addition of the fin diverters 150) is sufficiently small such that the heating/cooling characteristics of the thermal management apparatus 50, 50A, 50B are not significantly adversely affected. In other words, the thermal management apparatus 50, 50A, 50B as modified provides sufficient heating or cooling of the working fluid WF entering or exiting the inlet and outlet ports 81, 82 to maintain the desired performance characteristics of the system 30.

In one exemplary embodiment, as shown in FIGS. 9A and 9B, the heating plate 90 includes the first set 96A of fins 96 coupled to, other otherwise brazed onto, the first surface 92 of the heating plate 90 which are positioned in proximity to the lower surface 85 of the internal plate 83 adjacent to the inlet port 81 and a second set 96B of fins 96 coupled to, such as brazed onto, the first surface 92 of the heating plate 90 and positioned in proximity to the lower surface 85 of the internal plate 83 adjacent to the outlet port 82 which are separated by a central wall 91. The first surface 92 of the heating plate 90 also includes a flat portion that is disposed between the first and second sets 96A, 96B of fins 96 in which there are no fins brazed onto the first surface 92. This flat portion of the first surface 92 connects between the first and second sets 96A, 96B of fins 96 outwardly of the central wall 91 and opposite the inlet and outlet ports 81, 82. In other words, a portion of the first surface 92 of the heating plate 90 does not include the first set 96A of fins 96 and the second set 96B of fins 96, and wherein the one or more internal plate flow restrictor components 88 are positioned adjacent the portion of the first surface 92 of the heating plate 90 that does not include the first set 96A of fins 96 and the second set 96B of fins 96.

Preferably, each of the first and second sets 96A, 96B of fins 96 is an irregular polygon in shape, with the flat portion of the first surface 92 having a triangular shaped such that angled adjacent edge of the first set 96A of fins 96 is aligned with one triangular edge of the flat portion of the first surface 92, and such that the angled adjacent edge of the second set 96B of fins 96 is aligned with another triangular edge of the flat portion of the first surface 92.

In this configuration, the first and second sets 96A, 96B of fins 96 coupled to or brazed onto first surface 92 collectively define the heating plate flow restrictor components 96 that cover less of the surface area of the first surface 92 as compared with three sets 96A, 96B, 96C of fins 96 coupled to or brazed onto the first surface 92 of the heating plate 90 of conventional designs, such as less than ninety percent (90%), of the available surface area of the first surface 92 corresponding to the portion of flow path 120 of the working fluid WF between the inlet port 81 and outlet port 82. Also in these configurations, the corresponding heating elements 110 positioned on the second surface 93 of heating plates 90 are placed to correspond in location to three sets 96A, 96B, 96C of fins 96 coupled to or brazed onto the first surface 92, and thus also cover than ninety percent (90%), of the available surface area of the second surface 93 (and less than the surface area of heating elements 110 in conventional designs such as in FIG. 3).

To assist in transitioning the flow of working fluid WF from the first flow portion 120A to the second flow portion 120B, a sets of fin diverters 150 (shown in FIGS. 9A and 9B as three fin diverters 150) are cast onto the lower surface 85 of the internal plate 83 corresponding to the flat surface 89C. The fin diverters 150 are spaced relative to one another and may be c-shaped. A first end 151 of each of the fin diverters 150 terminates adjacent to the angled edge of the first set 96A of fins 96, while the opposing second end 153 terminates adjacent to the angled edge of the second set 96B of fins 96. Stated another way, each fin diverter 150 of the one or more fin diverters 150 extends between the first end 151 and the second end 153, with the first end 151 positioned adjacent to the first set 96A of fins 96 coupled to the first surface 92 of the heating plate 90 and the second end 153 positioned adjacent to the second set 96B of fins 96 coupled to the first surface 92 of the heating plate 90. The fin diverters 150 assist in directing the flow path 120 along various subchannels 121 to return the working fluid WF in a direction towards the outlet port 82 from the inlet port 81, or vice versa, along the respective first flow portion and second flow portion of the flow path 120.

In the configuration of the internal plate 83 and heating plate 90 in FIGS. 9A and 9B, while the total surface area is less than the corresponding surface area of FIG. 8 described above, the total surface area, in combination with the configurations of the heating plate 90, is sufficient to allow adequate heating, or cooling, or working fluid WF along the flow path 120 between the inlet port 81 and 82 for use in the thermal management apparatus 50, 50A, 50B while providing a less complex design with saving in both manufacturing and raw material costs.

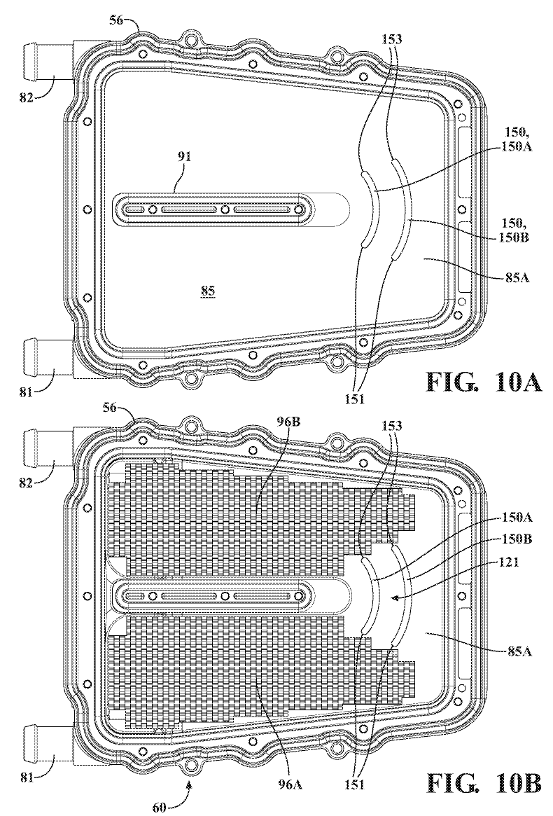

In another exemplary embodiment, as shown in FIGS. 10A and 10B, two spaced apart fin diverters 150A, 150B, are included, and each generally includes a similar c-shaped configuration to that as shown in FIGS. 9A and 9B. However, in this alternative configuration, the edges (i.e., an edge surface) of the first and second sets 96A, 96B of fins 96 are stepped (as compared with a generally straight edge as shown in FIGS. 9A and 9B), with a corresponding additional stepped flat surface added to the flat portion of the first surface 92 to accommodate the modification. In this configuration, the first end 151 and second end 153 of each fin diverter 150, 150A, 150B are aligned with a corresponding step in the stepped edge of the respective first and second sets 96A, 96B of fins 96. The additional removed fins 96 corresponding to the added stepped flat surface provide additional reduced surface area of coverage by the first and second sets 96A, 96B of fins 96 (and in certain alternative embodiments a corresponding step edge to the heating elements 110) as compared with the configuration in FIGS. 9A and 9B, leading to still further reduction in surface area of the fins 96 and heating elements 110 on the heating plate 90 of the heating plate assembly 60 to reduce complexity and cost without reducing performance.

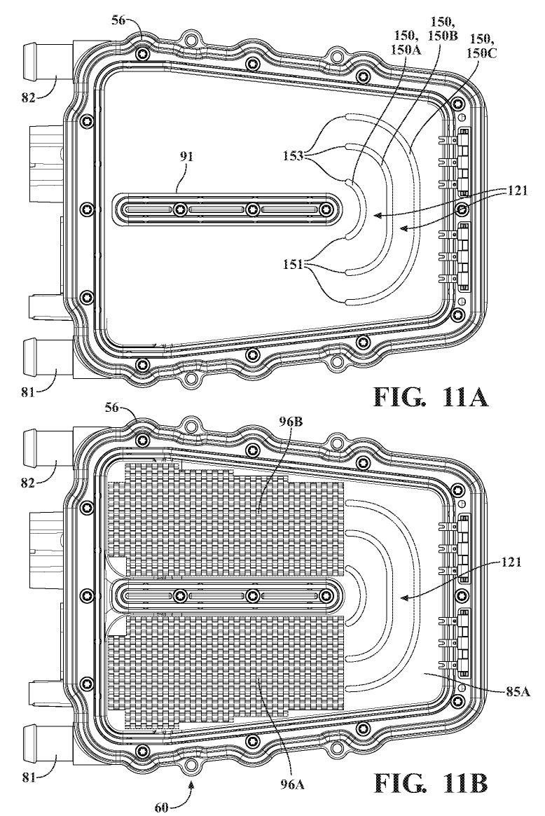

In still another embodiment, as shown in FIGS. 11A and 11B, the one or more fin diverters 150 (again shown here as three fin diverters 150A, 150B, 150C) coupled to or cast onto the flat surface 85A of the lower surface 85 are provided. However, in this embodiment, first and second sets 96A, 96B of fins 96 coupled to the first surface 92 of the heating plate 90 are rectangular shaped, such as square shaped, and the number of fins 96 is reduced to provide an additional flat surface on the first surface 92, and thus the respective angled edges are replaced by a respective squared edges. To accommodate the squared shape, the length of the fin diverters 150 are extended such that the first end 151 of each of the fin diverters 150 terminates adjacent to the squared edge of the first set 96A of fins, while the opposing second end 153 terminates adjacent to the squared edge of the second set 96B of fins. The additional removed fins 96 corresponding to the added flat first surface 92 provides additional reduced surface area of coverage by the first and second sets 96A, 96B of fins 96 (and in certain alternative embodiments a corresponding step edge to the heating elements 110) as compared with the configurations in FIGS. 9A-9B and 10A-10B, respectively, leading to still further reduction in surface area of the fins 96 and heating elements 110 on the heating plate 90 of the heating plate assembly 60 to reduce complexity and cost without reducing performance.

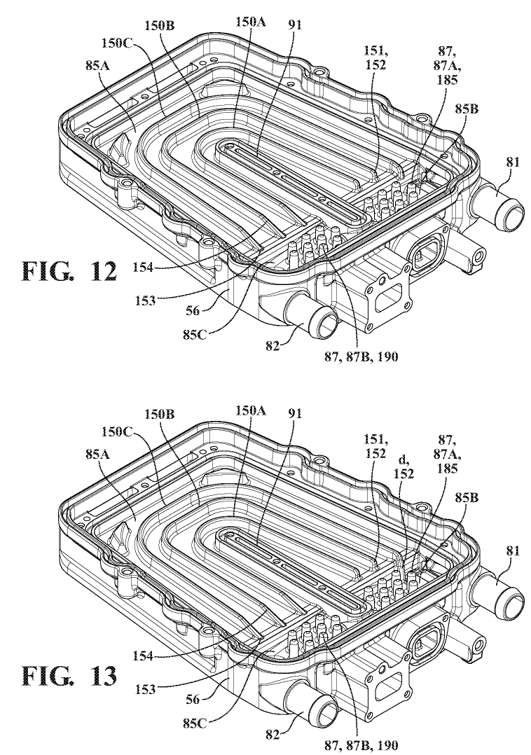

In addition, in still further embodiments as shown in FIGS. 12-19, the fin diverters 150 are extended around the central wall 91 and beyond the first portion 85A and towards the respective inlet port 81 and outlet port 82.

In addition, the one or more internal plate flow restrictor components 88 comprise one or more mixing posts 185, 190 coupled to the second surface 85 of the internal plate 83. More in particular, a first set 87A of flow altering components 87, here shown as a plurality of spaced apart mixing posts 185, are coupled to or otherwise disposed on another portion of the lower surface 85 adjacent to the inlet port 81. Still further, a second set 87B of flow altering components 87, here shown as a plurality of spaced apart mixing posts 190, are coupled to or otherwise disposed on another portion 85C of the lower surface 85 adjacent to the outlet port 82.

In certain embodiments, the plurality of spaced apart fin diverters 150 coupled to the second surface 85 of the internal plate 83 extend around the central wall 93 and between the first set 87A of mixing posts 185 and the second set 87B of mixing posts 190.

In each of these embodiments, the flow mixing posts 185 and 190 allow additional mixing of the working fluid WF adjacent to the inlet port 81 and outlet port 82, respectively as the working fluid WF moves along the flow path 120 between the inlet port 81 and outlet port 82.

In the illustrated embodiments of FIGS. 12-19, ten flow mixing posts 185, and ten flow mixing posts 190, are illustrated, respectively, with each in a diamond-pattern forming an overall rectangular shaped array and adjacent to the respective inlet port 81 and outlet port 82, with equal spacing occurring between each adjacent mixing post 185 or 190 and with the same cross-sectional diameter for each mixing post 185, 190. However, the number, configuration spacing and cross-sectional diameter of each of the flow mixing posts 185, 190 is not limited to the embodiment displayed, and may be the same or different as compared with each other flow mixing post 185 or as compared the corresponding flow mixing posts 190 in order to create the desired mixing of the working fluid WF adjacent the respective inlet port 81 and/or outlet port 82.

In each of these embodiments (not shown), the heating plate assembly 60 is configured with a corresponding reduced thickness of the fins 96 coupled to or brazed onto the first surface 92 of the plates 90, corresponding to the first set 96A, the second set 96B, and/or the third sets 96C of fins 96 (and in certain embodiments a corresponding rejection in the number of heating elements 110 are removed) so as to accommodate the thickness of the fin diverters 150 and/or the flow mixing posts 185, 190. The reduced thickness of the fins 96 results in reduced raw material costs and reduced complexity of manufacture while not reducing the performance of the system 30. In related embodiments, the number or location of fins 96 in one or more of the three sets 96A, 96B, 96C of fins 96 covering the respective fin diverters 150 and/or mixing posts 185, 190 may also be reduced, which can lead to further cost reductions in terms of manufacture or raw material costs without impacting performance.

Referring now to FIGS. 12-19, various alternative configurations for the fin diverters 150 are provided that each individually create slightly different flow characteristics for the working fluid WF flowing along the flow path 120 between the inlet port 81 and outlet port 82.

In FIG. 12, the first end 151 of each of the fin diverters 150A, 150B, 150C adjacent to the inlet port 81 is provided with a curled end 152, with the length of the curled end 152 of the outermost fin diverter 150C extended longer in length relative to the remaining fin diverters 150A, 150B. In addition, the second end 153 of each of the fin diverters 150A, 150B, 150C adjacent to the outlet port 82 is provided with a ramp 154 each of equal lengths.

In FIG. 13, the depth d of the curled end 152 of the outermost fin diverter 150C is not as deep as the curled end 152 of the outermost fin diverter 150C of FIG. 12, and does not extend to the additional portion of the first surface 92 adjacent the mixing posts 185.

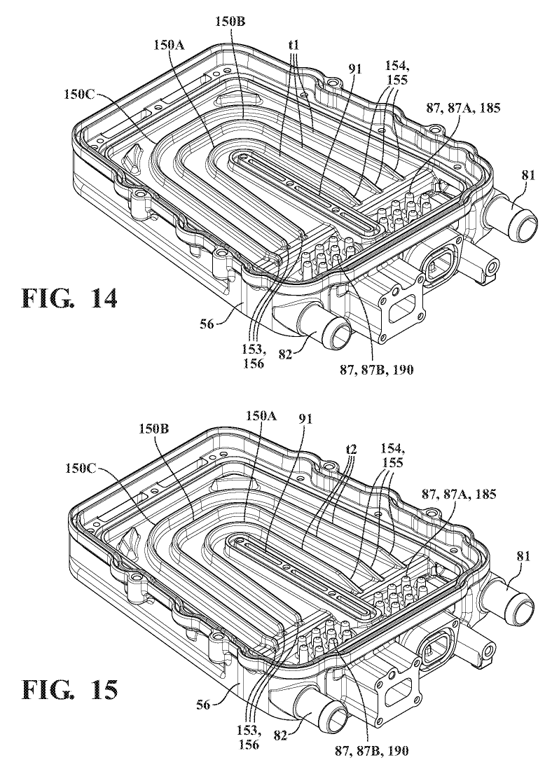

In FIG. 14, the configuration of curled ends 152 and ramps 154 is reversed from FIG. 12, wherein the first end 151 adjacent to the inlet port 81 is provided with ramps 155 and the second end 153 adjacent to the outlet port 82 includes the curled ends 156.

In FIG. 15, the thickness t2 of the fin diverters 150A, 150B, 150C are increased as compared with the thickness t1 of the corresponding fin diverters 150A, 150B, 150C of FIG. 14.

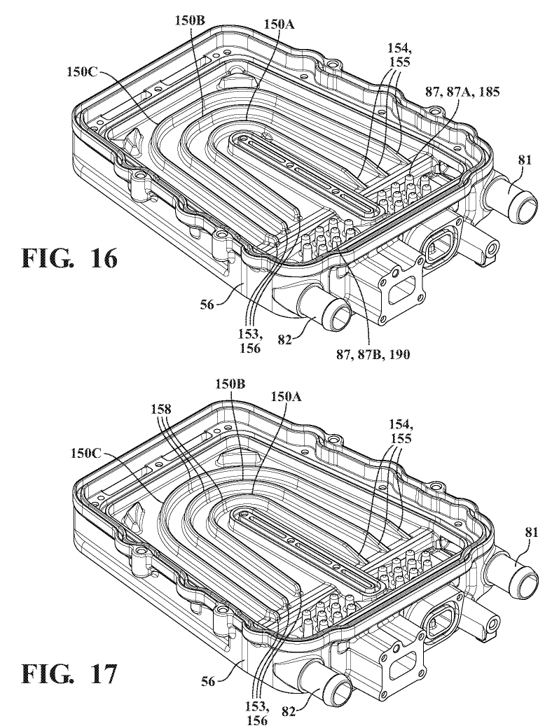

In FIG. 16, the length of the fin diverter 150B, at the second end 153, is shorter than the length of the fin diverter 150C but longer than the length of the fin diverter 150A. Correspondingly, in FIG. 15, the length of the fin diverter 150B, at the second end 153, is shorter than the length of the fin diverter 150C but equal than the length of the fin diverter 150A.

In FIG. 17, the shape of each of the fin diverters 150A, 150B, 150C is modified such that the middle portion 158 has a constant radius of curvature to form a precise c-shape as compared with the embodiment of FIG. 16.

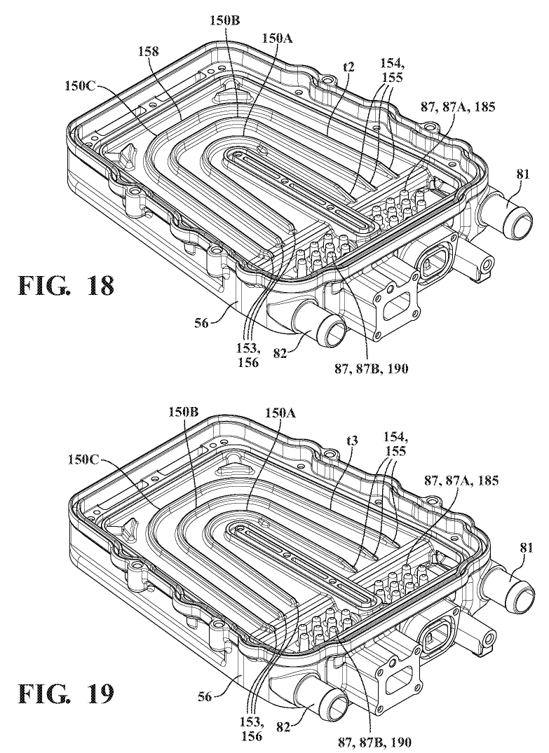

FIG. 18 is similar to FIG. 17, but includes wherein the middle portion 158 of the fin diverters 150C, 150B does not have constant radius of curvature.

Finally, in FIG. 19, the thickness t3 of each of the fin diverters 150A, 150B, 150C is reduced as compared with the thickness t2 of the corresponding fin diverters 150A, 150B, 150C of FIG. 18.

The subject disclosure provides various alternative configurations on the first surface 92 of the heating plate 90 of the heating plate assembly 60 in which the sets 96A, 96B, 96C of fins 96 are replaced by a plurality of cast fins 96.

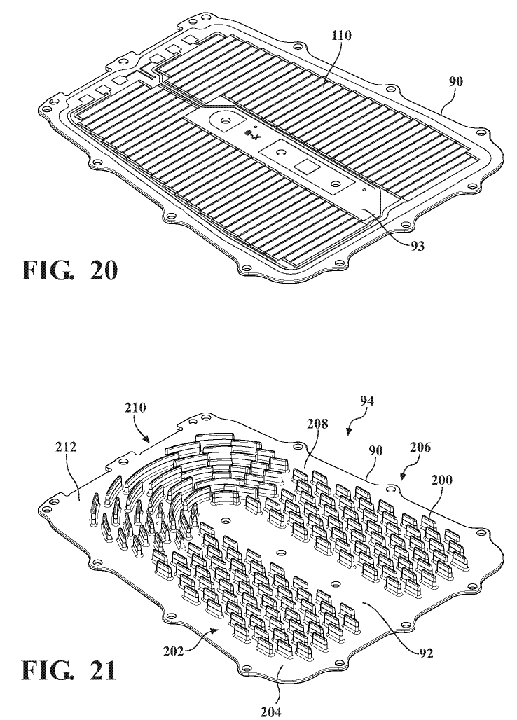

In one exemplary embodiment, which can be used alone or in combination with the internal plate 83 according to any of the embodiments above, as illustrated in FIGS. 20 and 21, the sets of stamped channels 94 comprise a plurality of fins 200 are cast upon the first surface 92 that replace the sets 96A, 96B, 96C of fins 96 illustrated in FIGS. 4-19.

In particular, in the embodiment of FIGS. 20 and 21, and as best shown in FIG. 21, a first set 202 of the plurality of fins 200 cast are positioned upon a first portion 204 of the first surface 92 adjacent to the inlet port 81 and a second set 206 of fins 200 cast are positioned on a second portion 208 of the first surface 92 adjacent to the outlet port 82. The first surface 92 also includes a third set 210 of fins 200 cast on a third portion 212 of the first surface 92 that connects between the first and second sets 202, 206 opposite the inlet and outlet ports 81, 82. The third set 210 of fins 200 collectively are curved into a c-shape to connect between the first and second sets 202, 206 of fins 200. The cast fins 200, together with the internal plate flow restrictor components 88 on the internal plate 83, collectively define the flow path 120 between the inlet port 81 and outlet port 82.

Also in FIGS. 20 and 21 and in accordance with additional exemplary embodiments, and as best shown in FIG. 20, the one or more heating elements 110 operatively attached to the second surface 93 of an outermost one of the plates 90 are aligned in size and shape with the first 202, second 204 and third sets 210 of fins 200 with the heating elements 110 in thermal communication with the first 202, second 204 and third sets 210 of fins 200 and with the flow path 120 through the plates 90.

In certain embodiments, the thermal management apparatus 50, 50A, 50B also includes a heat exchanger (not shown) operatively attached to the heating plate assembly 60 and contained within the housing 56. The heat exchanger further defines the flow path 120 within the thermal management apparatus 50, 50A, 50B. The heat exchanger flow path is in fluid communication with the heating plate assembly flow path 120 via the inlet port 81 and the outlet port 82 such that the heat exchanger flow path is configured to direct the working fluid WF therethrough.

The configuration of the heat exchanger is not necessarily limited for the purposes of this disclosure. In certain embodiments, the heat exchanger is a plate-type heat exchanger where the working fluid WF exchanges heat by flowing adjacent to each other between plates disposed parallel to each other. However, it is also contemplated that the heat exchanger may be other forms of a heat exchanger such as a tubular-type heat exchanger, a spiral-type heat exchanger, etc.

The arrangement of the various internal plate flow restrictor components 88 relative to the arrangement of the heating plate flow restrictor components 96 and heating elements 110 are a central aspect of the present disclosure and are used in distinguishing the various embodiments of the present disclosure as described above. In particular, the possible removal of the internal plate flow restrictor components 88, alone or in combination with the incorporation or arrangement of various alternative designs of the remaining internal plate flow restrictor components 88, alone or in combination with corresponding removal and/or incorporation or arrangement of various alternative designs of the heating plate flow restrictor components 96 and heating elements 110, reduces complexity and cost of the heating plate assembly 60 in combination with internal plate 83, and a corresponding reduction in the complexity and cost of the thermal management apparatus 50, 50A, 50B, and system 30 while maintaining the desired level of heating performance in the thermal management system 30 for heating or cooling the various components, such as the vehicle battery 36.

Several embodiments have been discussed in the foregoing description. However, the embodiments discussed herein are not intended to be exhaustive or limit the disclosure to any particular form. The terminology which has been used is intended to be in the nature of words of description rather than of limitation. Many modifications and variations are possible in light of the above teachings and the disclosure may be practiced otherwise than as specifically described.

What is claimed is:

1. A thermal management apparatus for use in a thermal management system of a vehicle to manage a temperature of a working fluid, the thermal management apparatus comprising:
a housing having an inlet port and an outlet port for the working fluid, the housing including an internal plate having a first surface and an opposing second surface, the second surface including one or more internal plate flow restrictor components; and
a heating plate disposed within the housing adjacent to and spaced from the internal plate, the heating plate having a first surface and an opposing second surface, the first surface of the heating plate including one or more heating plate flow restrictor components and the second surface of the heating plate including one or more heating elements,
wherein the one or more heating plate flow restrictor components on the first surface of the heating plate and the one or more internal plate flow restrictor components on the second surface of the internal plate each partially define a flow path for the working fluid therebetween with the one or more heating elements in thermal communication with the flow path for heating the working fluid as the working fluid flows through the flow path between the inlet port and the outlet port.

2. The thermal management apparatus of claim 1, wherein a portion of the first surface of the heating plate does not include the one or more heating plate flow restrictor components, and wherein the one or more internal plate flow restrictor components are positioned adjacent the portion of the first surface of the heating plate that does not include the one or more heating plate flow restrictor components.

3. The thermal management apparatus of claim 1, wherein the one or more internal plate flow restrictor components comprise one or more fin diverters coupled onto the second surface of the internal plate.

4. The thermal management apparatus of claim 1, wherein the one or more internal plate flow restrictor components comprise one or more mixing posts coupled to the second surface of the internal plate.

5. The thermal management apparatus of claim 1,
wherein the one or more heating plate flow restrictor components comprise a first set of fins coupled to the first surface of the heating plate adjacent to the outlet port and a second set of fins coupled to the first surface of the heating plate adjacent to the inlet port, with the first set of fins and the second set of fins separated by a central wall; and
wherein a portion of the first surface of the heating plate does not include the first set of fins and the second set of fins, and wherein the one or more internal plate flow restrictor components are positioned adjacent the portion of the first surface of the heating plate that does not include the first set of fins and the second set of fins.

6. The thermal management apparatus of claim 5, wherein each of the first and second set of fins coupled to the first surface of the heating plate is an irregular polygon in shape.

7. The thermal management apparatus of claim 6, wherein an edge surface of each of the first and second set of fins coupled to the first surface of the heating plate are stepped.

8. The thermal management apparatus of claim 5, wherein each of the first and second set of fins coupled to the first surface of the heating plate is rectangular in shape.

9. The thermal management apparatus of claim 1, wherein the one or more heating plate flow restrictor components on the first surface of the heating plate cover less than 90% of an available surface area of the first surface of the heating plate corresponding to the flow path of the working fluid between the inlet port and outlet port.

10. The thermal management apparatus of claim 9, wherein the one or more heating elements on the second surface of the heating plate cover less than 90% of an available surface area of the second surface of the heating plate and correspond in location along the second surface of the heating plate relative to the one or more heating plate flow restrictor components on the first surface of the heating plate.

11. The thermal management apparatus of claim 5, wherein the first and second set of fins coupled to the first surface of the heating plate cover less than 90% of an available surface area of the first surface of the heating plate corresponding to the flow path of the working fluid between the inlet port and outlet port.

12. The thermal management apparatus of claim 3, wherein the one or more fin diverters comprises a plurality of spaced apart fin diverters coupled to the second surface of the internal plate.

13. The thermal management apparatus of claim 12, wherein each fin diverter of the one or more fin diverters is c-shaped.

14. The thermal management apparatus of claim 12, wherein each fin diverter of the one or more fin diverters extends between a first end and a second end, with the first end positioned adjacent to the first set of fins coupled to the first surface of the heating plate and the second end positioned adjacent to the second set of fins coupled to the first surface of the heating plate.

15. The thermal management apparatus of claim 1, wherein the one or more internal plate flow restrictor components comprise:
a first set of spaced apart mixing posts coupled to the second surface of the internal plate adjacent to the inlet port;
a second set of spaced apart mixing posts coupled to the second surface of the internal plate adjacent to the outlet port; and
a plurality of spaced apart fin diverters coupled to the second surface of the internal plate and extending around a central wall and between the first set of mixing posts and the second set of mixing posts.

16. A thermal management system for a vehicle, said system comprising:
a thermal management apparatus comprising:
a housing having an inlet port and an outlet port for the working fluid, the housing including an internal plate having a first surface and an opposing second surface, the second surface including one or more internal plate flow restrictor components; and
a heating plate disposed within the housing adjacent to and spaced from the internal plate, the heating plate having a first surface and an opposing second surface, the first surface of the heating plate including one or more heating plate flow restrictor components and the second surface of the heating plate including one or more heating elements,
wherein the one or more heating plate flow restrictor components on the first surface of the heating plate and the one or more internal plate flow restrictor components on the second surface of the internal plate each partially define a flow path for the working fluid therebetween with the one or more heating elements in thermal communication with the flow path for heating the working fluid as the working fluid flows through the flow path between the inlet port and the outlet port; and
a controller configured to operate the thermal management apparatus.

17. The thermal management system of claim 16, wherein the one or more internal plate flow restrictor components comprise one or more fin diverters coupled onto the second surface of the internal plate, and/or
wherein the one or more internal plate flow restrictor components comprise one or more mixing posts coupled to the second surface of the internal plate.

18. The thermal management system of claim 16, wherein the first and second set of fins coupled to the first surface of the heating plate cover less than 90% of an available surface area of the first surface of the heating plate corresponding to the flow path of the working fluid between the inlet port and outlet port.

19. The thermal management system of claim 17, wherein the one or more fin diverters comprises a plurality of spaced apart fin diverters coupled to the second surface of the internal plate, and wherein each fin diverter of the plurality of spaced apart fin diverters is c-shaped.

20. The thermal management system of claim 19, wherein each fin diverter of the one or more fin diverters extends between a first end and a second end, with the first end positioned adjacent to the first set of fins coupled to the first surface of the heating plate and the second end positioned adjacent to the second set of fins coupled to the first surface of the heating plate.
